(19) United States
(12) Patent Application Publication
(10) Pub. No.: US 2005/0142517 A1
(43) Pub. Date: Jun. 30, 2005

(54) System for producing a dental implant and method

(76) Inventors: Howard Frysh, Dallas, TX (US); Henley S. Quadling, Dallas, TX (US); Mark S. Quadling, Plano, TX (US)

Correspondence Address: WILDMAN HARROLD ALLEN & DIXON, 225 WEST WACKER DRIVE, SUITE 2800, CHICAGO, IL, 60606, US

(21) Appl. No.: 10/975,515

(22) Filed: Oct. 28, 2004

Related U.S. Application Data
(63) Continuation-in-part of application No. 10/749,579, filed on Dec. 30, 2003.
(63) Continuation-in-part of application No. 10/804,694, filed on Mar. 19, 2004.
(63) Continuation-in-part of application No. 10/840,480, filed on May 5, 2004.
(63) Continuation-in-part of application No. 10/917,069, filed on Aug. 12, 2004.

(51) Int. Cl. A61C 8/00

(52) U.S. Cl. 433/173

(57) ABSTRACT

A system and method for producing a dental fixture are provided. A laser digitizer imaging system creates a visual three-dimensional image of a dental item such as a tooth or a dental impression. The three-dimensional image may be displayed and the size and shape of the image may be selectively modified by the user of the system. Digital data associated with the three-dimensional image of the dental item is sent to an implant production device. A dental implant is produced in response to receipt of the data associated with the three-dimensional image such that the implant is insertable into a socket of the jawbone from where a tooth was extracted.

### CROSS REFERENCE TO RELATED APPLICATIONS

This application is a continuation-in-part of U.S. patent application Ser. No. 10/749,579 filed Dec. 30, 2003 entitled “Laser Digitizer System for Dental Applications”, and a continuation-in-part of U.S. patent application Ser. No. 10/804,694 filed Mar. 19, 2004 entitled “Laser Digitizer System for Dental Applications”, and a continuation-in-part of U.S. patent application Ser. No. 10/840,480 filed May 5, 2004 entitled “Optical Coherence Tomography Imaging”, and a continuation-in-part of U.S. patent application Ser. No. 10/917,069 filed Aug. 12, 2004 entitled “Improved Milling Machine”, the complete disclosures of which are incorporated by reference herein.

### BACKGROUND OF THE INVENTION

1. Related Field

The invention relates to dental implants and systems and methods for producing and preparing dental implants.

2. Description of the Related Art

A dental implant may be inserted into the jawbone of a patient to provide a foundation for a dental prosthesis that replaces a missing tooth. Conventional implants are often comprised of titanium or titanium coated material and are generally elongated cylindrical screw-like devices which have outer threads to engage with the jawbone and a hollow inner-portion for receipt of a mating abutment. Dental implants provide a foundation for the dentist to place an artificial tooth or crown in order to restore dental function to the patient.

Integration of the bone to the implant is an important aspect of implant securement and positioning. One or more dental burs are used by a dentist (or other surgical specialist) to prepare the site in the jawbone for placement of the implant. The implant is then placed into the prepared site or surgical site formed in the jawbone and a sealing screw may be placed in the implant. After the implant is placed, there is a healing period of approximately three to six months in order for the jawbone to grow around and fuse with the implant by a process known as osseointegration. Once the implant is secured in the jawbone, an abutment member (or post) is attached to the implant. The abutment joins the implant and a dental prosthesis (such as an artificial tooth or crown) and functions as the support for the dental prosthesis. Once the prosthesis is made, after dental impressions are taken, the prosthesis is fitted and attached to the abutment extending from the implant.

One early form of dental implantation employed blade implants made of chrome cobalt type metal. To place these blade implants, the dentist prepares a groove into exposed bone in a mesial distal direction. The blades are generally thicker than the formed groove and are tapped into place ensuring a tight fit. The blades also have a projection coming out of the bone into the oral cavity to support the prosthesis. At times, problems occur with such blade implants due to epithelium growing between the blade and the bone as a result of micromotion or overheating of the bone during preparation, incorrect texture of the surface, or placement of the blade in less dense cancellous bone.

When conventional implants are placed into a healed extraction site, the healed site is usually shrunken resulting in the healed area having a smaller volume especially in the bucco lingual and occlusal apical dimensions. This often provides a challenge of using an implant of the correct size in length and diameter in order to provide the strength to bear the load. Additionally, when placing an implant into a healed extraction site, the dentist drills a hole into exposed bone under very specific conditions of speed and cooling so as not to overheat the bone. Then, depending on the implant selected, the implant is either tapped or screwed into place. The success of the implant is dependent on the close fit of the implant to the bone and the stability of the implant so that the bone can grow and integrate directly with the implant.

When a fresh extraction has taken place, the placement of an implant often poses a challenge. This is due to the socket or void in the bone being much longer than most implants and even when larger or expandable implants are employed, they periodically have difficulty properly integrating with the bone. Additionally, conventional implantation involving fresh extraction often requires preparation that is apical to the extraction site which tends to be a more invasive procedure.

One implanting approach that is used after a tooth is removed at a fresh extraction site involves placing freeze-dried bone into the socket and placing a membrane over the socket to stop soft tissue from growing over and into the socket. This prevents the socket space from collapsing and allows healthy bone to accept a conventional implant. Another approach is to prepare a hole for receipt of the implant that is deeper than the socket in order to stabilize the implant. Freeze-dried bone is then placed between the implant and the bone and a membrane is placed over the opening to the socket. This invasive approach requires a high degree of training, involves high cost and requires a lengthy healing time.

### SUMMARY OF THE INVENTION

Embodiments of a system and a method for producing a dental fixture having a dental implant are provided. A laser digitizer imaging system creates a visual three-dimensional image of a dental item such as a tooth or a dental impression. The three-dimensional image may be displayed and the size and shape of the image may be selectively modified by the user of the dental implant production system. Data associated with the three-dimensional image of the dental item is sent from the laser digitizer imaging system to an implant production device. A dental implant is produced in response to receipt of the data associated with the three-dimensional image. The dental implant may mimic the shape of a root portion of the tooth such that the produced implant is insertable into a socket of the jawbone from where the tooth was removed.

### BRIEF DESCRIPTION OF THE DRAWINGS

FIG. 1 is a block diagram of a dental implant production system.

FIG. 2a illustrates a top view of one example of a laser digitizer imaging system for dental applications.

FIG. 2b illustrates a front view of the exemplary laser digitizer imaging system of FIG. 2a for dental applications.

FIG. 3 illustrates an image of a light pattern of the laser digitizer imaging system of FIGS. 2a and 2b, as viewed on a flat surface.

FIG. 4 illustrates the light pattern of FIG. 3 as projected on a dental tooth to be imaged.

FIG. 5 illustrates a reflection of the light pattern of FIG. 3 as detected by image capture instrument.

FIG. 6 illustrates an embodiment of an object positioner of the laser digitizer imaging system of FIGS. 2a and 2b.

FIG. 7 illustrates an example of an intra-oral laser digitizer imaging system for dental applications.

FIG. 8 illustrates an example of an intra-oral laser digitizer imaging system configured as an optical coherence tomography (“OCT”) or confocal sensor.

FIG. 9 is a perspective view of an example implant production device.

FIG. 10 is a perspective view of a carriage of the implant production device of FIG. 9 that controls x-axis movement of spindles.

FIG. 11 is a cut-away view of a spindle showing a collet that engages a cutting tool.

FIG. 12 is a perspective view of a sub-assembly that controls the y-axis and z-axis of the implant production device.

FIG. 13 illustrates an example of imaging a tooth and producing a dental implant.

FIG. 14 illustrates an example imaging a tooth having a curved root portion and producing a dental implant.

FIG. 15 is a flow chart illustrating an example of the steps of producing a dental implant from a dental item.

### DETAILED DESCRIPTION

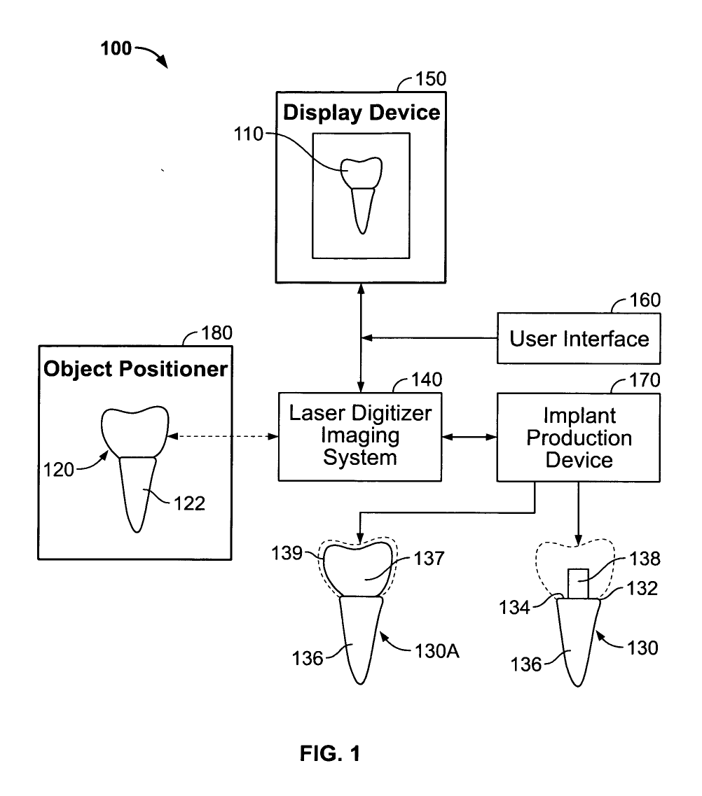

FIG. 1 illustrates an example of a dental implant production system 100 configured to generate a three-dimensional image 110 of a dental item such as a tooth 120 and for producing a dental implant 130 from the image obtained from the tooth. The dental item may alternatively be a dental impression formed from inserting impression material into a socket at an extraction site from where a tooth was removed. The dental impression formed is imaged and a dental implant is produced from data associated with the image of the dental impression. Other dental items may include bridges, inlays, crowns, onlays, copings, frameworks, veneers and the like. The dental implant production system 100 includes an imaging system 140, display device 150, user interface 160, and implant production device 170. The dental implant production system 110 may also include an object positioner 180 to hold and position an extracted tooth or other dental item 120 within a field of projection of the imaging system 140. Alternatively, an intra-oral imaging system may be used to image the dental item such as a tooth 120 (as well as adjacent teeth) from the mouth of the patient (in vivo) before extraction.

The imaging system 140 may be a laser digitizer imaging system having a scanner which optically scans a portion of the tooth 120. For instance, the imaging system 140 will optically scan the tooth 120 in order for the dental implant 130, formed at the implant production device 170, to be insertable into the socket of a patient's jawbone that previously held the tooth. As an example only, the description herein discusses imaging and production of an implant from data associated with the image of the tooth. However, it is understood that imaging of a dental impression or other dental items may be performed in producing the dental implant. The imaging system 140 receives reflected light signals upon scanning the tooth 120 and creates a three-dimensional image 110 of the portion of the tooth 120 being scanned. Some portions of the tooth 120 may be obscured due to shadowing effects or areas where the projected light cannot reach. In order to obtain full coverage, multiple three-dimensional images are obtained from suitable vantage points in order to represent the entire surface area of the tooth 120. The imaging system 140 captures data by imaging reflected light and computes three-dimensional data which describes the surface of the portion of the tooth 120 being imaged. If multiple images are obtained, the images are combined into a single three-dimensional combined image by transforming each image according to known transformation parameters, or transforming each image so that common areas between the images are aligned. A display device 150, such as a cathode ray tube (CRT) device, computer monitor, computer system and display, display screen, or other suitable display device is coupled with the imaging system 140 and displays the three-dimensional image 110 of the tooth 120 for viewing by the user of the dental implant production device 100.

User interface 160 coupled with the imaging system 140 allows the user (such as a dentist or other dental professional) to modify the shape and size of the image obtained in order for the implant production device 170 to produce a dental implant 130 in accordance with the modifications made. The user interface 160 may be a keyboard, mouse, touch pad, touch screen, track-ball, screen actuation probe, slider, or any other suitable interface to convey information to the imaging system. The implant production device 170 is coupled to the imaging system 140 and receives data associated with the three-dimensional image 110 of the tooth from the imaging system. For example, the implant production device 170 may receive data which may include standard tool-path data as commonly used by commercial CNC milling machines. The tool-path data may instruct cutting tools of a particular size and shape at the implant production device 170 to machine a block of material into a shape which corresponds to the three-dimensional image 110 of the tooth from the imaging system 140. Alternative forms of analog or digital data may also be employed to produce a dental implant from the imaged tooth.

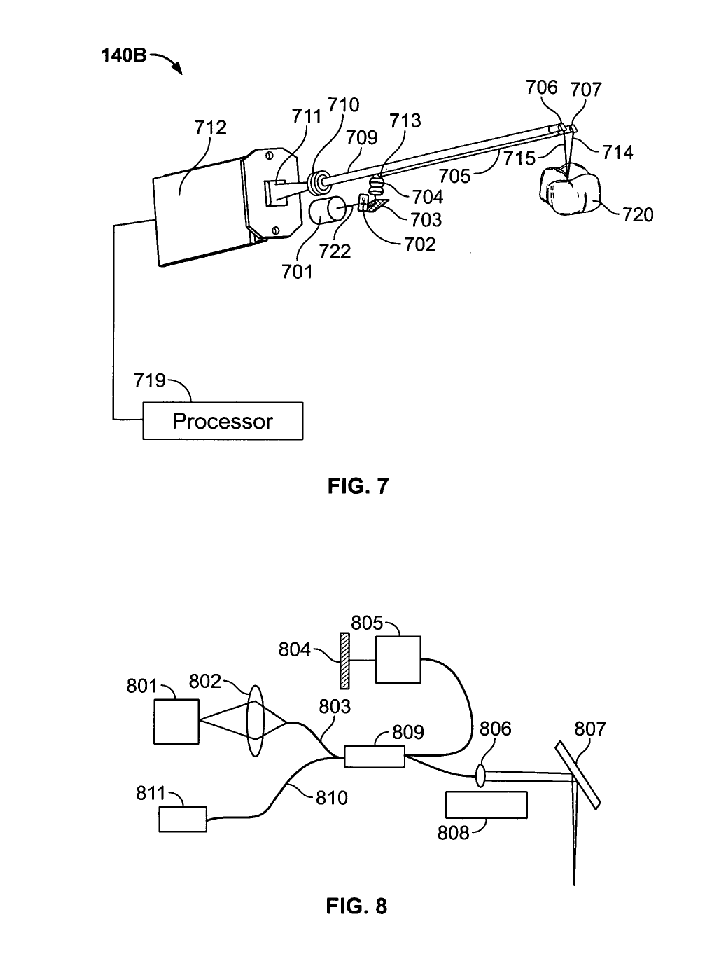

The implant production device 170 produces the dental implant 130 in response to receipt of the data associated with the three-dimensional image 110. The user may also selectively design a dental prosthesis such as a dental crown to be inserted on the dental implant, preferably at an abutment extending from the implant. In some instances, imaging of neighboring or opposing teeth, or both, may be performed using an intra-oral laser digitizer imaging system (FIGS. 7, 8) for performing in vivo imaging of the teeth when designing a dental crown prosthesis. Once the particular design for the dental crown is made by the user interacting with the imaging system 140, a temporary crown, formed from a composite block placed at production device 170, may be milled for placement upon a dental implant.

The implant production device 170, FIG. 1, in one example, may be a milling machine which is programmable to mill a solid piece of material to form the dental implant 130 based on data received from the imaging system 140. The milled material may be a titanium block; however, other suitable biocompatible materials may be employed. The implant production device 170 forms the dental implant 130 to mimic the shape of the tooth 120 that was imaged. In particular, the implant production device 170 is capable of forming the dental implant to mimic the original shape of the root portion 122 (or a portion thereof) of the tooth 120 such that the implant 130 may be tapped into position and seated in a fresh socket of the jawbone from where the tooth was extracted.

In order to optimize the implantation procedure, the size and shape of the images taken from the tooth 120 can be adjusted by the imaging system 140 based on user input. The implant production device 170 produces the dental implant 130 in accordance with such adjustments and modifications to meet the desired specifications of the user (e.g. dentist). For instance, the user interface 160 allows the actual size of the three-dimensional image 110 to be selectively adjusted by the user inputting information related to the size modification into the imaging system 140. In order to create stability in the bone, and also prevent soft tissue from entering the cavity socket, and to provide a tight fit, the thickness of the occlusal third (the upper portion of the implant) or some other portion can be made larger (relative to the corresponding occlusal third portion of the imaged root which was in the bone), depending on the site, and age group of a patient. If the root portion 122 of the tooth is curved, the curved portion is typically found at the apical third of the root. A tight fit in the fresh socket of the jawbone at the occlusal third of the inserted implant will act to prevent migration of soft tissue into the cavity. Thus, depending on the shape of a tooth having a curved portion at its root 122, the user may elect to forego reproducing the curved portion of the root, as seen in FIG. 14, in the titanium block by making appropriate adjustments via user interface 160 to the three-dimensional data obtained for the imaged tooth 110. If a curved root portion is not produced for the implant 130, bone will grow into the void in the socket apical to the root after the implant is inserted into the socket.

If the length of the root 122, FIG. 1, of the imaged tooth 120 is long, such that an inserted implant 130 would be close to a critical nerve or other structure, the length of the implant 130 to be formed may be changed or shortened by adjusting the three-dimensional data associated with the imaged tooth 110 to avoid encroaching on critical anatomical sites such as inferior alveolar nerve or the sinus cavity. Thus, if the tooth has a root that is undesirably long or is curved making insertion of an implant with such a curved shape difficult, the three-dimensional data associated with the root portion of the tooth image may be modified such that a corresponding root portion 136 of the dental implant 130 may be omitted by the implant production device 170, as seen in FIG. 14. The data associated with the three-dimensional image of the root portion of the tooth is truncated. The implant production device 170, FIG. 1, accordingly will not mill the full length of the root in accordance with the tool-path data that is generated from the modified three- dimensional data. In multi-rooted teeth, one or more of the roots 122 may selectively be imaged and formed in the produced dental implant 130 depending on the situation. Imaging of the roots 122 may selectively be done separately, because the roots may be divergent.

If the root 122 of the tooth 120 being imaged is fractured or broken so that it cannot be digitized, an accurate dental impression material may be placed and pressed into the socket to form a dental impression. An impression may also be made of a prepared site, in which the socket has been prepared after a tooth extraction. In this case, the original socket may not be optimal for an implant, and additional modification is made to the socket prior to producing an impression of the socket. In one example, the dental implant may be produced by extracting a tooth from the mouth of a patient and then various dental procedures may be performed at the socket from where the tooth was removed to create a prepared site. Impression material is then inserted into the prepared site to form the dental impression and the dental impression (or a portion thereof) is imaged by imaging system 140. The dental impression is then digitized and the same procedure is followed as for an intact root of a tooth. Once the data has been captured by the imaging system 140, it is presented on the display device 150 to the user, who may manipulate the three-dimensional data associated with the displayed image 110 via the user interface 160.

The implant production device 170 will then produce the dental implant 130 that may selectively have a size that is different than the size of the tooth 120 being imaged. The user, for example, may desire the tooth shaped dental implant 130, or a portion thereof, to be slightly larger (e.g. 2 mm) than the original size of the corresponding tooth portion 120, in order for the dental implant to fit tightly in the socket created in the mouth of the patient. The dental implant 130, or portions thereof, may, for example, selectively be formed to be 0%-30% larger than the original size of the corresponding portion of the tooth 120. For instance, the user may desire to make the occlusal third (or portions thereof) of the implant 10% or more larger than the corresponding portion of the tooth being imaged to optimize a secure fit in the socket. Alternatively, apical portions of the implant such as root portions may be formed to have a size that is the same (or shortened in length) relative to the corresponding apical portion of the tooth. The user inputs the selected size adjustment at the user interface 160 and the imaging system 140 is programmed to make the modification to selected portions of the image 110. The shape of the socket may be modified by controlled preparation by drilling small holes into the cortical bone (and not overheating the bone), in order to improve blood supply and aid acceptance of the implant produced by the implant production device 170. It may be necessary to lengthen the socket in order to optimize the implantation.

The user may also selectively utilize user interface 160 to direct the imaging system 140 to modify the surface of the three-dimensional image 110 obtained. Modifications to the size of the upper portion of the three dimensional image 110 may be made by means of a user interface element in the user interface 160 (such as a slider or other similar control) which allows for the user to selectively and interactively change the size of the three-dimensional root model. If the user desires to truncate the apical portion of the root of the three-dimensional image 110, for example, due to excessive length or curvature, user interface elements in the user interface 160 are provided to effect this change on the display device 150 interactively. An example of a user interface would be a slider which allows the user to choose a range (such as 0-30%) which instructs software operating at the imaging system 140 the extent to which the size modifications need to be made. Alternatively, user interface 160 interacting with imaging system 140 may provide selection of regions of the three dimensional data (generating displayed image 110) using a mouse, cursor or similar interface allowing for interaction with and modification of the displayed image 110. In this way, regions in the three dimensional data associated with the displayed image 110 may be selected and then modified. The modifications on the selected portions of the image may include truncation, scaling, or other geometric modifications.

The user may also utilize the user interface 160 to modify the texture of the surface of the three-dimensional image 110. In this way, the implant 130 produced by the implant production device 170 may have a surface texture or quality that is optimal for the application. The computer controlled imaging system 140 may modify or eliminate a portion of the tooth imaged or change the particular contour of the tooth image in response to user input at the user interface 160. One example of a user interaction may include use of a three-dimensional data viewer which allows the user to view the data set associated with the displayed image from all vantage points. The user interface 160 operating with imaging system 140 may also include tools to view the three dimensional data along any predefined axis. The user interface may also include a mechanism interacting with imaging system 140 to identify the principal axis of a tooth root, and to display the principal axis.

The computer controlled imaging system 140 may also provide indication to the user, by means of shading or other means displayed on display device 150, of which portions of the three dimensional data may pose a problem. For example, if the root is very long or curved, so that it would be difficult or not appropriate to insert an identical solid machined metal implant into the socket, then operable software at the computer controlled imaging system 140 may identify which portions of the lower part of the displayed image 110 and corresponding implant should be truncated. The user interface 160 operating with imaging system 140 may include tools to enable cross sectional views of the three dimensional data.

Regions on the three-dimensional data may be detected automatically by the software running at imaging system 140, or chosen by the user. Automatic detection may include the automatic identification of the occlusal portion of the root, so that it may be scaled in size in the correct range so as to effect a tight and stable fit for the final implant. Manual selection may include standard three-dimensional software selection schemes, through the use of direct interaction with the three-dimensional data by means of keyboard commands, mouse or trackball motions by themselves, and in combination with various keyboard combinations. User modification tools may be offered through a toolbar or menu displayed on display device 150, which provide such utilities as automatic detection of regions, automatic scaling or modification of selected regions (according to parameters defined in another user interface element), and automatic truncation or deletion of portions of the three dimensional data associated with the imaged tooth.

Once the desired size and shape are selected and the appropriate modifications are made to the image 110 being displayed, the imaging system 140 transmits data associated with the tooth image to the implant production device 170. In one example, the computer controlled imaging system 140 calculates and generates tool path data to be received at implant production device 170 based on the three-dimensional data for the modified image. Alternatively, the modified three-dimensional data may be sent from the imaging system 140 to the implant production device 170 that converts the three-dimensional imaging data to tool path data that provides milling instructions at the implant production device. The implant production device, such as a milling machine which mills an inserted titanium block, responsively produces the dental implant 130 having a size and surface contour associated with the modified image 110 of the tooth.

Once the user has modified the three-dimensional image 110 to his satisfaction, the data associated with the modified image may be sent to the implant production device 170. In one example, the implant production device 170 has one or more spindles with attached cutting or grinding tools or burs. Depending on the size, shape and configuration of the cutting tools or burs, the programming at the computer based implant production device 170 calculates or receives a tool path which instructs the implant production device on where to grind or cut away material from the titanium block, based upon the three-dimensional data generated at the imaging system 140.

The imaging system 140, in response to user operation of the user interface 160, selectively adjusts the shape of the three-dimensional image 110 such that the dental implant 130 produced at the implant production device 170 is able to be seated directly back into a fresh socket of the jawbone. The user adjusts the three-dimensional data associated with image 110 displayed on the display device 150 in order for the implant production device 170 to form an implant 130 that will be optimal for bone integration in accordance with the implant site. For instance, if the root portion of the extracted tooth is curved, the implant may need to be modified (via adjustment to the image data obtained) such that the implant will be able to be tapped into place in a controlled manner, fitted and seated in the corresponding fresh socket of the jawbone.

In another example, the imaging system 140, in response to user input at the user interface 160, adjusts the data associated with the shape of the tooth image 110 such that the implant production device 170 forms the dental implant 130 with a wide portion 132 proximate a top end 134 which opposes a root portion 136 of the implant. The wide portion 132 is positioned proximate the opening of the socket upon implant insertion so as to reduce the chance of soft tissue interfering with the healing of the bone below the gingiva. The material (e.g. a titanium blank), inserted into the implant production device 170 for milling, may selectively have the facility to allow an abutment to be screwed into the dental implant. Alternatively, implant production device 170 may be programmed to form an abutment 138 extending from the wide portion 132 at the top end 134 of the implant. The abutment 138 may be automatically generated by the implant production device 170 or based upon user input to modify the image at display device 150 to include the tooth abutment. The abutment 138 may have a width ranging from approximately 50% to 70% of the width of the wide portion 132 of the implant 130. The height of the abutment 138 may be determined according to the space required to place a crown.

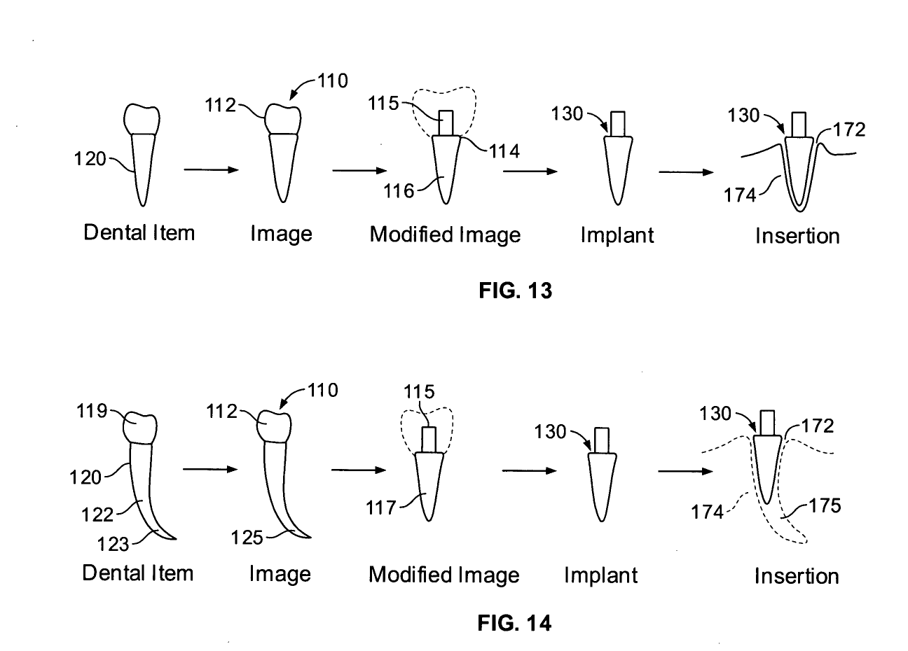

The implant production device 170 may produce a dental implant 130A, Fig., having an abutment portion 137 that is formed as an integral part of the dental implant such that the abutment portion 137 is positioned at an occlusal part 139 of the dental implant atop of the root portion 136. The occlusal part is generally the portion of the implant which supports a dental prosthesis, such as a dental crown, located proximate to biting or chewing surfaces. The imaging system 140 scans a tooth 120 (or other dental item) and generates a displayed image 110 of the tooth. Data associated with the three-dimensional image 110 is modified to design an abutment portion 115 (FIG. 13) of the three-dimensional image of the tooth or other dental item being imaged. The design of the abutment image 115 may be accomplished by user interaction with interface 160, FIG. 1, as described above, to modify the three-dimensional data relating to the displayed image 110. Alternatively, the abutment portion design may be automatically generated based on predetermined parameters set at the imaging system 140 to modify the three-dimensional image data in response to the imaging of the particular dental item 120. The dental abutment image may selectively have a design which mimics a shape and contour of a corresponding ideal crown preparation of the dental item being imaged. The design of the abutment image, in some instances, may also be selected to have a corresponding size and thickness that is smaller than the size and thickness of an ideal dental crown for the tooth being imaged, without undercuts. The abutment portion 137 of the dental implant 130A will be produced at implant production device 170 to have a size and shape that corresponds to the design for the abutment portion of the three-dimensional image 110 in accordance with the modified three-dimensional image data. The machined dental implant 130A, for example, may have an abutment portion 137 that is smaller than a corresponding non-root portion or crown of the imaged tooth 120 in order to permit the placement of a prosthetic dental crown with an optimum thickness according to manufacturer specifications for the crown material.

As described herein, a three-dimensional digitizer of the laser digitizer imaging system 140 captures data, by imaging reflected light from the imaged tooth 120, and the computer controlled imaging system 140 computes three-dimensional data which is associated with the surface of the imaged tooth. The user, via user interface 160 coupled with the computer controlled imaging system 140, is able to manipulate and modify the three-dimensional data, stored in the imaging system, that is associated with the imaged tooth. A three-dimensional image 110 of the tooth 120, or portions thereof, is displayed for viewing by the user at display device 150 coupled with the imaging system and the user interface.

The occlusal third or some portion of the dental implant 130, for example, may be made slightly larger than the corresponding portion of the imaged tooth 120 to provide enhanced stability of the implant inserted into the tooth socket at the extraction site. Any excessive length or curve at the bottom portion of the tooth may also be truncated when forming the dental implant 130. The surface texture for the dental implant may also be specified by the user. The user may select a surface quality, for example, through interaction with a slider which offers the choice of a range from “smooth” to “rough”, or a numerical range which is representative of a final finish quality on the final milled implant. The choice of cutting tool and the tool-path parameters that may be selected by the user may also result in different surface textures. The user may also design a prosthesis such as a dental crown to be attached to the dental implant preferably via an abutment integral to the occlusal portion of the implant. Once the particular shape and size of the dental crown are designed by the user through interaction at user interface 160, a temporary crown formed from a composite block or similar suitable material (inserted at production device 170) may be milled for engagement with a formed dental implant.

Tool path programming at the implant production device 170 (e.g. a computer controlled milling machine) computes a tool path which is dependent on the particular configuration of the implant production device. Tool path data may alternatively be computed at the computer controlled imaging system 140 upon generation or modification of the three-dimensional image data. The tool path will depend, for example, on the relative position of the single or multiple spindles with respect to motion axes (e.g. translation or rotational axes) of the implant production device. The tool path will also depend on the size and shape of the tooth (corresponding to the implant to be produced) as well as the geometry of the three-dimensional designed implant to be milled.

Referring to FIG. 13, the steps of imaging an extracted tooth or dental impression, modifying the image obtained, producing a dental implant, and inserting the implant into a fresh socket created upon removal of the tooth are illustrated. Initially the tooth 120 (or impression) is scanned by the lazer digitizer imaging system 140 which creates a three-dimensional image 110 of the tooth for display at the display device 150. Through selective input at the user interface 160, the user may modify data associated with the size or shape of the displayed three-dimensional image 110 to design a dental implant in an effort to optimize the implant procedure based on the characteristics of the implant site. For example, the user may modify the image to remove the crown portion 112 (or other non-root portion) of the tooth imaged 110 and to form a relatively flat and wide portion 114 proximate the occlusal end of the root portion 116 imaged to establish a generally “T-shaped” lid of the dental implant to be produced. Alternatively, a separate disc shaped lid may be attached on the occlusal portion of the implant to prevent the epithelium from growing into the extraction site and the lid is removed when placement of an abutment or final crown is made.

Once image modifications are made, if any, the imaging system 140 transmits information, such as three-dimensional image data or tool-path data, associated with the selected image to the implant production device 170 which prepares a dental implant 130 based on the information received from the imaging system. After the dental implant 130 is produced it may be inserted into the mouth of the patient by controlled tapping or screwing the implant into the socket 172 of the jawbone 174 previously housing the tooth 120. The dental implant 130 formed has a size and shape that mimics portions of the extracted tooth so that it may immediately be firmly inserted into a fresh socket 172 and allow the bone 174 to grow into and integrate with the implant.

FIG. 14 provides an illustrated example of imaging a dental item such as a tooth or dental impression having a curved root portion and producing a dental implant. As seen in FIG. 14, root 122 of tooth 120 has a curved portion 123. The tooth 120 is scanned by imaging system 140 to create a three-dimensional image of the tooth displayed at display device 150. Initially, the image 110 displayed at display device 150 may include image display of a corresponding crown portion 112 and curved root portion image 125. The user interacts with user interface 160 (and imaging system 140) to modify the three-dimensional data associated with the displayed image to create a modified image 117. The modified image 117 may have the imaged crown portion 112 and the imaged curved root portion removed to design an implant meeting user desired specifications. The modified image 117 may selectively include an abutment portion 115 extending proximate an end of the root portion image. The imaging system 140 transmits three-dimensional data, or alternatively tool-path data, associated with the modified image 117 to the implant production device 170 which prepares a dental implant 130 based on the received data associated with the modified image. Once produced, the implant 130 is inserted into the socket 172 that previously held the tooth and the bone 174 will grow into the void 175 located proximate a root end of the implant that is placed into the socket.

In some instances the root portion 122 of the tooth 120, FIG. 14, is at an angle relative to the non-root portion 119 (e.g. crown portion or occlusal part) of the tooth. In such cases, the angle between the root portion 119 and the non-root portion 122 of the tooth 120 is determined by the imaging system 140 or alternatively, through manual observation by the user. The tooth 120 (or other dental item) is imaged by imaging system 140 and the three-dimensional image of the dental item is displayed at display device 160. The shape of the three-dimensional image 110 is selectively modified to create an abutment portion 115 extending from a root portion 117 of the modified three-dimensional image. Through interaction with user interface 160 coupled with imaging system 140, the user is able to selectively position the abutment portion 115 of the displayed three-dimensional image at an angle relative to the root portion 117 of the three-dimensional image such that the positioned angle will mimic the angle between the root portion 122 and the non-root portion 119 of the tooth 120 that is being imaged. The implant production device 170 will produce an implant having an abutment positioned at an angle relative to a root portion of the implant in accordance with the modified three-dimensional image. Thus, when the dental implant 130 is placed into the socket 172 previously retaining the tooth 120, the abutment 138 of the implant will be positioned at a desirable angle to accept a dental crown prosthesis. The produced dental implant 130 may also have markings on its surface to assist the user in orienting the dental implant for insertion into the socket. In some instances, employment of an intra-oral laser digitizer imaging system (FIGS. 7, 8) may be used to image the tooth 120 (in vivo) as well as neighboring and opposing teeth to determine a desirable angle to be established between the abutment and root portion of the modified image and the corresponding dental implant.

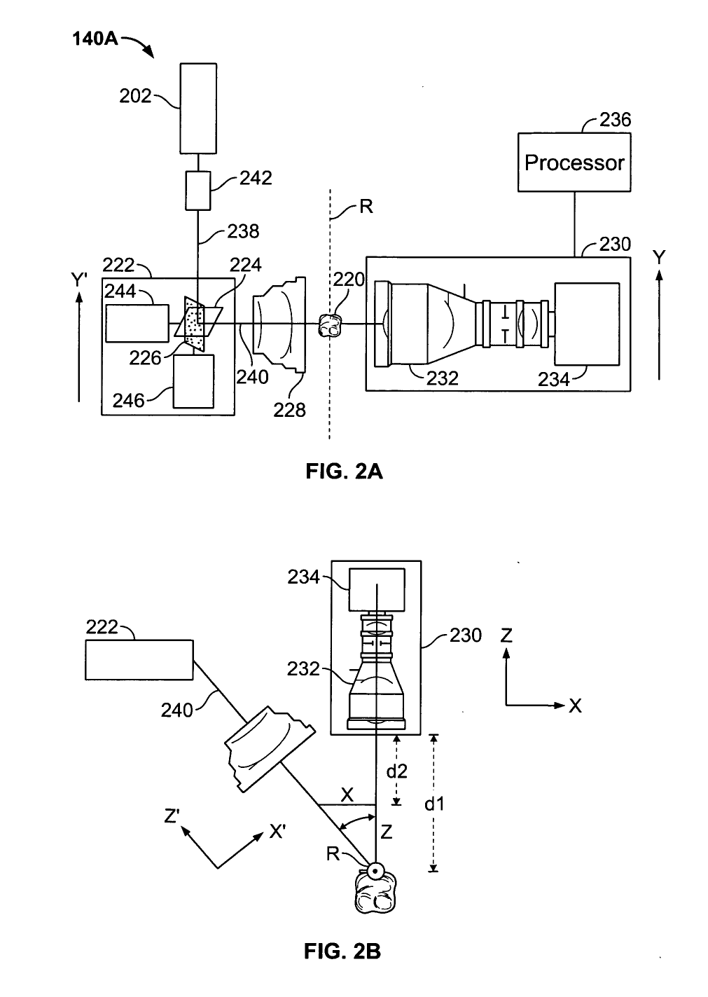

FIGS. 2a and 2b illustrate an example of the imaging system which in this example is a laser digitizer imaging system 140A configured to generate a three-dimensional (3D) image of a tooth 220, dental impression or other dental items. The laser digitizer imaging system 140A includes a laser light source 202, an optical scanner 222, a flat-field lens 228, that may be known as an F-Theta lens, an image capture instrument 230, and a processor 236. The processor 236, for example, may include programming to display the imaged tooth 110 and modify the data used to generate the three-dimensional image. In one example, processor 236 of computer controlled imaging system 140 may also be programmed to generate tool-path data converted from the three-dimensional image data and to transmit the tool-path parameters to the implant production device 170. The laser digitizer imaging system 140A may also include a positioner (not shown) for securing and positioning the tooth to be imaged. The laser digitizer imaging system 140 may also include a variable beam expander 242 optically positioned between the laser source and the scanner 222. For further details on the laser digitizer imaging system, reference can be made to U.S. patent application Ser. No. 10/749,579 filed Dec. 30, 2003 for “Laser Digitizer System for Dental Applications” of Quadling et al. which is incorporated in its entirety herein by reference.

The laser light source 202 generates a laser beam that is projected and scanned across a tooth to be imaged by the scanner 222 and the F-Theta lens 228. The scanned light is reflected from the tooth 220 and detected by the image capture instrument 230, which generates a signal representative of the detected light.

The laser light source 202 may include collimating optics (not shown) that produce a collimated light beam 238 having parallel rays of laser light. This collimated light beam 238 is projected towards a two-axis optical scanner 222.

The laser light source 202 may include a laser diode or LED configured to generate a laser light beam that may have an elliptical-shaped beam. The collimating optics may be configured to circularize the elliptical beam and to generate a circular spot. The circular spot may be used to scan a uniform line across the surface of the tooth 220. The laser diode may be any commercially available laser diode configured to emit a laser light beam, such as a 10 mW laser diode from Blue Sky Research having a 4 mm beam size at a 635 nm wavelength (part number MNI-0635-1 01C40W).

The laser light source 202 also may be configured to modulate laser light. The laser light source 202 also may be coupled to a modulator that adjusts or interrupts light flow from the source at high modulation or switching rate such as 20 MHz rate. By switching the laser light source 202, the coherence of the laser light emitted from the laser light source 202 may be reduced, thereby reducing speckle.

The scanner 222 redirects or scans the collimated light beam 238 to form a scanned light beam 240 having a position that may vary over time. The scanned beam 240 is directed by the scanner 222 to the F-theta lens 228. The scanner 222 redirects the collimated light beam across two axes where each axis is substantially perpendicular to the axis of the collimated light beam 238. The scanned light beam 240 may be scanned in at least two or more axes.

The scanner 222 includes a first reflector 224 and a second reflector 226. The first and second reflectors 224, 226 may comprise optical mirrors or surfaces capable of reflecting undiffused light to form an image. Each reflector 224, 226 may be rotatably coupled with a respective motor 244, 246. Each motor 244, 246 may comprise a galvo drive motor, or the like, that controls a rotational movement of the respective reflector 244, 226 to effect the scanning of the collimated light beam 238.

The first and second reflectors 224, 226 may have essentially perpendicular axes, and may be essentially orthogonal with respect to each other. The reflectors 224, 226 also may be positioned at an arbitrary angle relative to each other. Additional reflectors may also be included. The reflectors 224, 226 may be positioned orthogonally so that the collimated laser beam 238 incident on the reflectors may be scanned or redirected in at least two axes. The first reflector 224 scans the beam along one axis, such as an x-axis. The second reflector 226 may be positioned so that the beam along the x-axis incident upon the second reflector 226 may be scanned along an orthogonal direction to the x-axis, such as a y-axis. For example, the first and second reflectors 224, 226 may be positioned orthogonal with respect to each other so that the first reflector scans the beam along the x-axis and the second reflector 226 scans the beam along an orthogonal direction to the x-axis, such as a y-axis.

The first reflector 224 also may comprise a spinning polygon mirror such that the rotatable second reflector 226 and the spinning polygon reflector 224 together also are configured to scan the laser beam in two axes. The spinning polygon mirror 224 may scan the collimated light beam 238 along an x-axis and the rotatable mirror 226 may scan the collimated light beam along a y-axis. Each axis, the x-axis and y-axis, may be substantially orthogonal with one another, thereby generating a scanned light beam 240 from the collimated beam 238 where the scanned light beam 240 is scanned along two substantially orthogonal axes.

The scanner 222 also may include a programmable position controller. The position controller may be a component of the scanner 222 or may be incorporated with the processor 236. By incorporating the position controller with the scanner 232, computing resources of the processor 236 are available for other functions such as processing the image data or for more advanced processing. The position controller may comprise a commercially available controller such as the GSI Lumonics SC2000 Scanner Motion Controller which controls the scanning of the two reflectors. The controller may be configured to control the movement of the reflectors 224, 226 by controlling the motors 244, 246. The controller controls the movement of the reflectors 224, 226 so that the collimated laser beam 238 is redirected to provide to a desired scan sequence. A coordinate system for the scanner 222 is referred to as X′Y′Z′.

The scanned beam 240 is incident to the F-Theta lens 228. The F-theta lens 228 focuses the scanned beam 240 to a point or dot. The tooth 220 to be imaged is positioned within a field of view of F-Theta lens and the image capture instrument 230. The F-theta lens 228 has an optical axis at an angle 0 with respect to an optical axis of the image capture instrument 230 so that when the focused dot is scanned across the surface of the tooth 220 the light is reflected towards the image capture instrument at angle θ. The scanner 222 moves the scanned beam 240 so that the focus point of the laser dot from the F-Theta leans 228 traverses through a pattern across the surface of the tooth 220. The F-Theta lens 228 may be any commercially available lens such as part number 4401-206-000-20 from Linos, having a 160 mm focal length, a 140 mm diagonal scanning length, ±25 degree scanning angle and 633 nm working wavelength.

The image capture instrument 230 may be configured and/or positioned to have a field of view that includes the focused laser dot projected on the tooth 220. The image capture instrument 230 detects the laser dot as it is scanned across the surface of the tooth 220. The image capture instrument 230 may be sensitive to the light reflected from the tooth 220. Based on a light detected from the tooth 220, the image capture instrument generates an electrical signal representative of the surface characteristics (e.g., the contours, shape, arrangement, composition, etc.) of the tooth 220.

The image capture instrument 230 may include an imaging lens 232 and an image sensor 234. The imaging lens 232 is configured to focus the light reflected from the tooth 220 towards the image sensor 234. The imaging lens 232 may be a telecentric lens configured to minimize perspective errors. The imaging lens 232 may have an internal stop configured to image mostly parallel rays incident at a lens aperture to reduce or eliminate an effect of magnification and perspective correction. The imaging lens 232 may be any commercially available lens configured to minimize perspective distortions such that a lateral measurement on the image of a tooth does not depend on the distance of the tooth from the lens such as the China Daheng Corp. combination with front lens number GCO-2305 (50 mm diameter) and the back lens number GCO-2305 (8 mm diameter) where the back lens corresponds to the imaging capture instrument sensor size.

The image sensor 234 captures an image of the scanned surface of the object. The image sensor 234 may be a photo-sensitive or light sensitive device or electronic circuit capable of generating signal representative of intensity of a light detected. The image sensor 234 may include an array of photodetectors. The array of photodetectors may be a charge coupled device (“CCD”) or a CMOS imaging device, or other array of light sensitive sensors capable of generating an electronic signal representative of a detected intensity of the light. The image sensor 234 may comprise a commercially available CCD or CMOS high resolution video camera having imaging optics, with exposure, gain and shutter control, such as Model SI-3170-CL from Silicon Imaging of Troy, N.Y. The image sensor 234 also may include a high bandwidth link to a framegrabber device, such as the PIXCI CL1 capture and control computer board from Epix, Inc.

Each photodetector of the array generates an electric signal based on an intensity of the light incident or detected by the photodetector. In particular, when light is incident to the photodetector, the photodetector generates an electrical signal corresponding to the intensity of the light. The array of photodetectors includes multiple photodetectors arranged so that each photodetector represents a picture element, or pixel of a captured image. Each pixel may have a discrete position within the array. The image capture instrument 230 may have a local coordinate system, XY such that each pixel of the scanned pattern corresponds to a unique coordinate (x,y). The array may be arranged according to columns and rows of pixels or any other known arrangement. By virtue of position of the pixel in the array, a position in the image plane may be determined. The image capturing instrument 230 thereby converts the intensity sensed by each pixel in the image plane into electric signals that represent the image intensity and distribution in an image plane.

The CMOS image sensor may be configured to have an array of light sensitive pixels. Each pixel minimizes any blooming effect such that a signal received by a pixel does not bleed into adjacent pixels when the intensity of the light is too high.

The scanner 222 may be configured to scan the laser beam 240 across the surface of the object 220 via the F-Theta lens 228 in many desired patterns. The pattern may be selected to cover a sufficient portion of the surface of the tooth 220 during a single exposure period. The pattern may also comprise one or more curves or any known pattern from which the characteristics, elevations and configurations of the surface of the tooth 220 may be obtained.

During an exposure period, an image of a portion of the surface of the object is captured. The beam 240 scan the tooth 220 via the scanner 222 and the F-Theta lens 228 in a selected pattern, allowing the imaging sensor 230 to detect the light reflected from tooth 220. The image sensor 230 generates data representative of the surface characteristics, contours, elevations and configurations of the scanned portion or captured image. The data representation may be stored in an internal or external device such as a memory.

During a subsequent scan period, the beam 240 is scanned in a pattern across an adjacent portion of the tooth 220 and an image of the adjacent portion is captured. The scanned beam 240 may scan a different area of the surface of the tooth 220 during subsequent exposure periods. After a several exposure periods in which the beam 240 is scanned across the various portions of the tooth 220 and images of those scanned portions captured, a substantial portion of the tooth may be captured.

The processor 236 is coupled to the image capture instrument 230 and configured to receive the signals generated by the image capture instrument 236 that represent images of the scanned pattern on the tooth 220.

The processor 236 also may be coupled to the laser light source and control selected or programmed applications of the laser light. The processor 236 also 10 may be coupled with the scanner 222 and programmed to control the scanning of the collimated light 238.

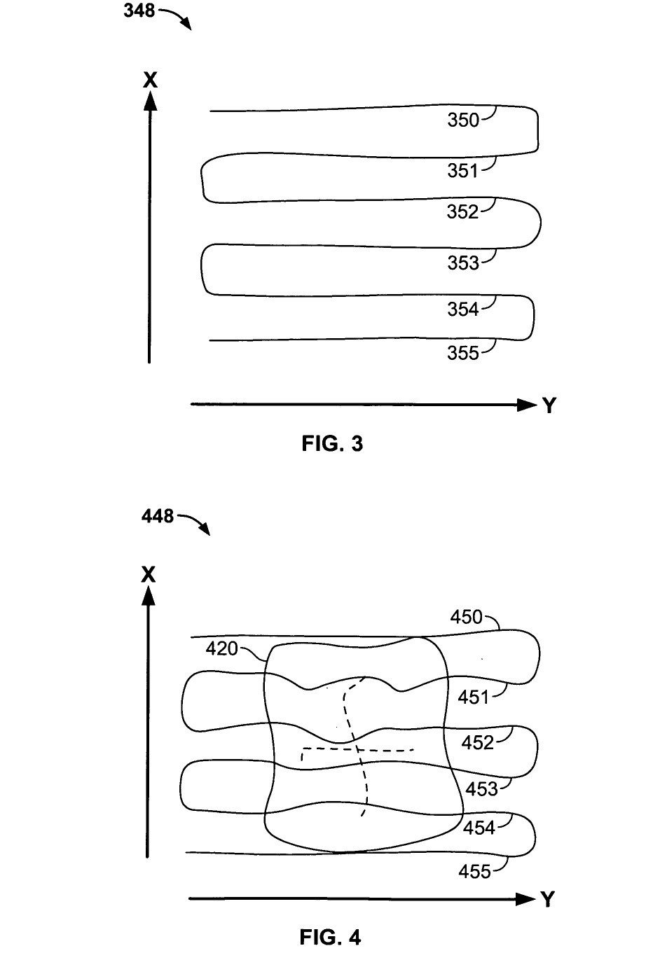

FIG. 3 illustrates an example of a scanned pattern of light 348 as viewed from a substantially flat surface. The scanned pattern 348 may include multiple curves 350-355 that are generated by the scanner 222. A portion of the curves 350-351 may be essentially parallel to each other. The curves 350-355 also may represent or include a connected series of points or curvilinear segments where a tangent vector n at any single point or segment obeys the following rule:
|n·R|≠0 (1)
where R is a triangulation axis that is substantially parallel to Y and Y′ and passes through an intersection of an axial ray from the image capture instrument 230 and an axial ray from the optical scanner 222. Accordingly, the angle between the tangent n at any point or segment of the curve and the triangulation axis R is not 90 degrees. Each curve 350-355 also may have a cross-sectional intensity characterized by a function that may have a sinusoidal variation, a Gaussian profile, or any other known function for cross-sectional intensity. In an embodiment, a minimum angle between a valid ray between the scanner 222 relative to a valid axial ray of the image sensor 234 is non-zero.

The image capture instrument 230 may be characterized by a local coordinate system XYZ, where the X and Y coordinates may be defined by the image capture instrument 230. A value for the Z coordinate may be based on the distance d₁ and d₂ so that d1≦z≦d2. A point from a projected curve incident to a plane perpendicular to Z will appear to be displaced in the X direction by Δx. Based on a triangulation angle, the following condition may exist:

$$Δ z = \frac{Δ x}{Tan θ} \qquad ( 2 )$$

For a given curve (e.g. curve 350) in the projection pattern there may be unique relations θ(y), z_{base}(y) and X_{base}(Y). The relations θ(y), z_{base}(Y) and X_{base}(y) relations may be determined through calibration. The calibration may be performed for example by observing the curve 350 as projected on a plane surface. The plane surface may be perpendicular to the image capture instrument 230 at two or more distances d along the Z axis from the image capture instrument 230. For each y value along the curve 350, using at least two such curves with known z values of z₁, and z₂, where z₁<z₂, Δz may be computed as Δz=z₂−z₁. A value Δx may be observed using the image capture instrument 230. Using equation (2), θ(y) may be computed. The corresponding value z_{base}(Y) may be set equal to z₁. The corresponding value x_{base}(y) may be equal to an x value at the point y on the curve corresponding to z₁. Additional curves may be used to improve accuracy of through averaging or interpolation.

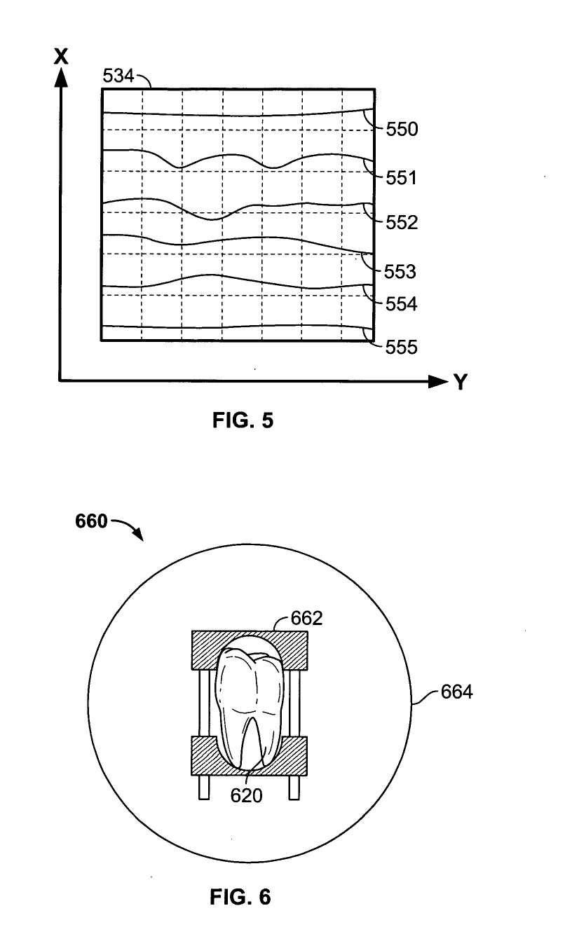

FIG. 4 illustrates the scanned pattern of light 448 incident to the object 420 to be imaged. FIG. 5 illustrates the light pattern reflected from the object 420 as incident to the image sensor 534. For the observed projected curves 550-555 on the tooth, each curve corresponds to one of the curves 450-455 shown in FIG. 4 and a corresponding one of the curves 350-355 shown FIG. 3. Accordingly, for each curve 550-555, the corresponding relations θ(y), z_{base}(y) and x_{base}(y) may be selected that were precomputed during a calibration. For each point (X_{observed},Y_{observed}) on each curve 550-555,
Δx=_{observed}−x_{base}(y_{observed}) (3)
Equation (2) may be used to determine Δz using θ(y_{observed}), and consequently
z_{observed}=Δz+z_{base}(y_{observed}) (4)
The collection of points (x_{observed}, y_{observed}, z_{observed}) obtained, form a 3D image of the tooth 420.

A maximum displacement for a curve may be determined by:
Δx=(d₁−d₂)Tan θ (5)
A maximum number of nₘₐₓ of simultaneously distinguishable curves 350 may be determined according to nₘₐₓ=Xₘₐₓ/Δx or equivalently

$${n}_{max} = \frac{{X}_{max}}{( {d}_{1} - {d}_{2} ) Tan {θ}_{max}} \qquad ( 6 )$$

The number nₘₐₓ increases with a decreasing depth of field d₁-d₂ and increases with a smaller θₘₐₓ. The accuracy of the determination also may decrease with a smaller θₘₐₓ values.

FIG. 6 illustrates an example of an object positioner 660. The positioner 660 is configured to secure and position a tooth 620, impression or other dental item to be imaged in the field of view of the scanned laser beam 240 and the image capture instrument 230. The positioner 660 may include two or more rotary axes to provide for rotation of the tooth 620. The tooth 620 may be rotated with respect to the coordinate system XYZ of the image capture instrument 230. The positioner 660 also may include a linear axis to linearly adjust the tooth 620 to a focal point for the scanning system and image capture unit 230 system.

The positioner 660 also may include a platform 664 and a spring loaded clamp 662. The spring-loaded 662 clamp may be configured to securely hold an extracted tooth 620. The clamp 662 also may have magnets (not shown) so that it may be rigidly secured through magnetic attraction to the positioning platform 664. This tooth 620 may be quickly positioned with the laser imaging system by securing it into the clamp 662 and placing the clamp onto the platform 664. The tooth 620 may be moved or adjusted with respect to the platform 664 to a desired the position appropriate for digitizing the region of interest.

Referring now to FIG. 7, an alternative embodiment of a laser digitizer imaging system 140B is shown. FIG. 7 illustrates an example of an intra-oral laser digitizer imaging system 140B. The intra-oral digitizer imaging system 140B generates a three-dimensional image of an object 720 such as a tooth, dental impression or other dental item. The intra-oral laser digitizer imaging system 140B generates a laser pattern that may be projected on or towards tooth, a dental item, dentition, or prepared dentition in an oral cavity (in vivo). The intra-oral digitizer system 140B may remotely generate the laser pattern and relay the pattern towards the dental item or items in vivo. The laser pattern may be relayed through relay optics such as prisms, lenses, relay rods, fiber optic cable, fiber optic bundles, or the like. The intra-oral laser digitizer system 140B also may detect or capture light reflected from the tooth or other dental item in vivo. The intra-oral laser digitizer imaging system 140B, or a portion thereof, may be inserted in the oral cavity to project the laser pattern and to detect the reflected laser pattern from the tooth, dental item or items in the oral cavity. The captured light may be used to generate data representative of the three-dimensional image of the dentition. The data is used to display the three-dimensional image 110, FIG. 1. The data associated with the three-dimensional image is used to form a model of the tooth for use as a dental implant using known techniques such as milling techniques. For further details on the intra-oral laser digitizer or imaging system, reference can be made to U.S. patent application Ser. No. 10/804,694 filed Mar. 19, 2004 for “Laser Digitizer System for Dental Applications” of Quadling et al. which is incorporated in its entirety herein by reference.

The laser digitizer imaging system 140B, FIG. 7, includes a laser light source 701, a first scanner 702 (x scanner), a second scanner 703 (y scanner), a lens assembly 704, a first reflecting prism 713, a first optics relay 705, a second reflecting prism 707, a third reflecting prism 706, a second optics relay 709, imaging optics assembly 710, imaging sensor 711, and an electronic circuit 712. The intra-oral laser digitizer imaging system 140B is also coupled to processor 719 which is selectively programmed to display and modify three-dimensional image data and may also be programmed to generate tool-path parameter data for use at implant production device as previously described.

The laser light source 701 may include collimating optics (not shown) that generate a laser beam of light 722 from the light source 701. The collimated light beam 722 is characterized by parallel rays of laser light. The laser beam 722 is projected to the first scanner 102.

The laser light source 701 may include a laser diode or LED that generates a laser light beam having an elliptical-shaped cross-section. The collimating optics may be configured to circularize the elliptical beam and to generate a circular spot. The circular spot may be used to scan a uniform line across the surface of the object 720 (e.g. tooth in vivo). The laser diode may be any commercially available laser diode configured to emit a laser light beam, such as the Blue Sky Research Mini-Laser 30 MWatt laser with 0.6 mm collimated beam, model number Mini-635D3D01-0.

The laser light source 701 also may modulate the laser light beam. The laser light source 701 may be coupled to a modulator that adjusts or interrupts light flow from the source at high modulation or switching rate. The modulation may be in the range of substantially 1 kHz to substantially 20 MHz. A scan pattern may be generated on the object, by modulating the laser light source 701.

The first scanner 702 includes an x-scanner mirror having a substantially flat reflecting surface. The reflecting surface of the x-scanner mirror, may be rectangular-shaped having dimensions approximately 1.5 mm by approximately 0.75 mm. The laser beam 722 from the light source 701 may have a width no greater than the smallest dimension of the first scanner 702. For example, the width of the laser beam may be approximately 0.6 mm. The beam of light 722 from the laser light source 701 is incident upon the reflecting surface of the first scanner 702.

The second scanner 703 includes a y-scanner mirror having a substantially flat reflecting surface. The reflecting surface of the y-scanner mirror, may be rectangular-shaped having dimensions approximately 1.5 mm by approximately 0.75 mm. The reflecting surfaces of the x-scanner and the y-scanner may be mirrors or the like.

FIG. 8 illustrates an alternative embodiment of an intra-oral laser digitizer imaging system configured as an optical coherence tomography (“OCT”) or confocal sensor. Optical coherence tomography may be used for performing in vivo imaging of dental items such as a root portion of a tooth or dental impression. The laser digitizer system of FIG. 8 includes a fiber-coupled laser 811. The laser source 811 may be a low coherence light source coupled to a fiber optic cable 810, coupler 809 and detector 801. The coupler, an optical delay line 805 and reflector 804 return delayed light to the coupler 809. The coupler 809 splits the light from the light source into two paths. The first path leads to the imaging optics 806, which focuses the beam onto a scanner 807, which steers the light to the surface of the object. The second path of light from the light source 811 via the coupler 809 is coupled to the optical delay line 805 and to the reflector 804. This second path of light is of a controlled and known path length, as configured by the parameters of the optical delay line 805. This second path of light is the reference path.

Light is reflected from the surface of the object (e.g. tooth) and returned via the scanner 807 and combined by the coupler 809 with the reference path light from the optical delay line 805. This combined light is coupled to an imaging detector system 801 and imaging optics 802 via a fiber optic cable 803. By utilizing a low coherence light source and varying the reference path by a known variation, the laser digitizer provides an Optical Coherence Tomography (“OCT”) sensor or a Low Coherence Reflectometry sensor. The focusing optics 806 may be placed on a positioning device 808 in order to alter the focusing position of the laser beam and to operate as a confocal senor. For further details on the laser digitizer imaging system utilizing optical coherence tomography, reference can be made to U.S. patent application Ser. No. 10/840,480 filed May 5, 2004 for “Optical Coherence Tomography Imaging” of Quadling et al. which is incorporated in its entirety herein by reference.

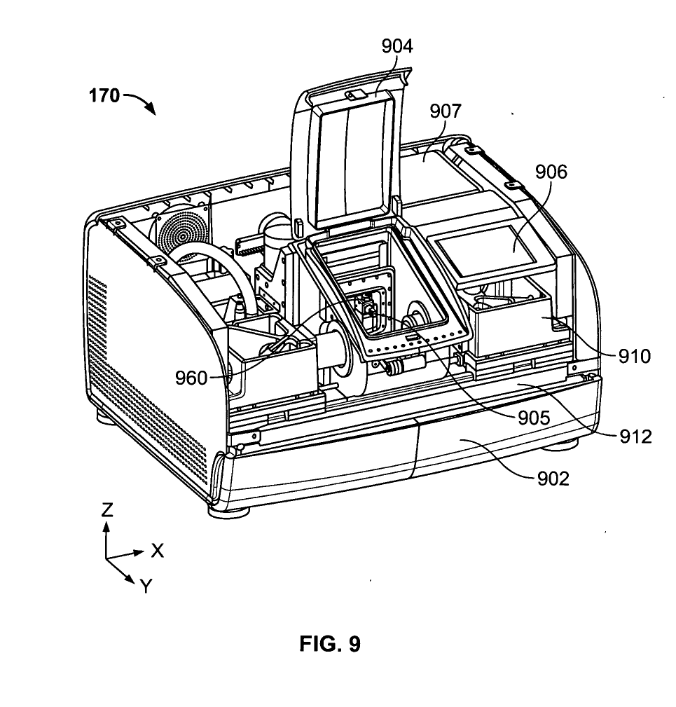

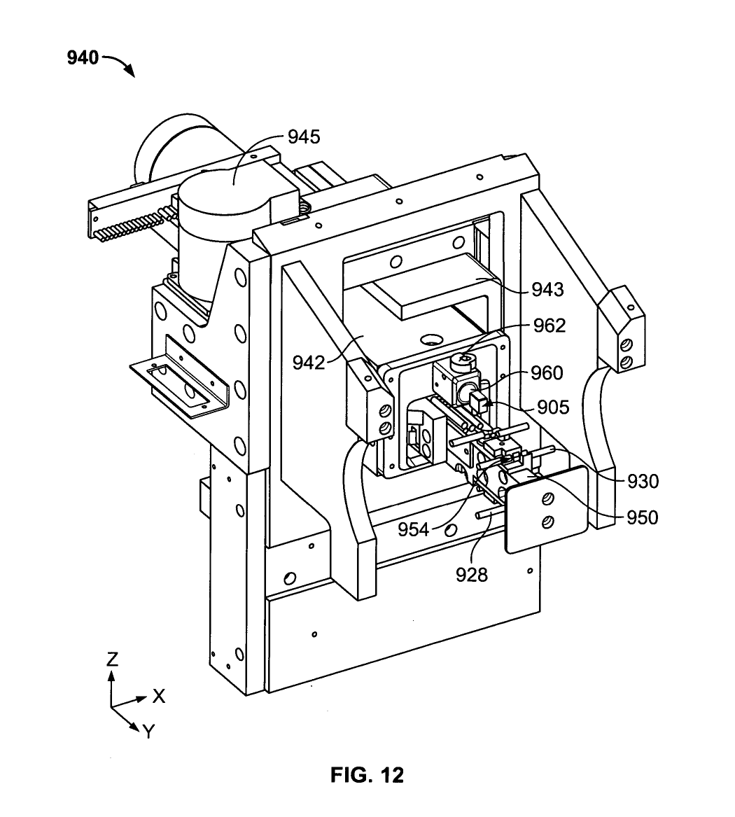

Referring now to FIG. 9, one example of an implant production device 170 is shown characterized as a milling machine having a sturdy frame 902 to minimize vibration. The implant production device 170 has spindles that rotate milling bits located on a common rail, giving the device the ability to move cutting tools attached to the spindles in the x-axis. A blank 905, such as a titanium block, is positioned within and is releasably attached to a mandrel 960. The mandrel 960 is secured to a subassembly 940 (FIG. 12) having a y-axis carriage 942 and a z-axis carriage 943 that allows motion in the y-axis and the z-axis. The block 905 to be milled is held by the mandrel that engages a frame within a work area that is easily accessible to the user (such as a dentist or other dental technician). The implant production device 170, FIG. 9, includes a central processing unit (CPU) and memory for storing data received from the imaging system 140 on the contour of the implant or other dental item to be produced. The central processing unit at implant production device 170 may receive tool-path parameter data received from the imaging system 140 (formed from the three-dimensional image data also generated at imaging system). The tool-path parameter data provides instructions to the implant production device 170 on how to perform to produce a dental implant. Alternatively, the CPU at implant production device 170 may receive three-dimensional image data from the imaging system 140 and generate the tool-path parameter data associated with the displayed image itself at the production device.

As described above, a laser digitizer imaging system such as an intra-oral laser digitizer system 140B, FIG. 7, may be used to measure the dimensions of the tooth 120, FIG. 1, as well as the adjacent and opposed teeth. Software within the laser digitizer system constructs an outer contour that meshes with the adjacent and opposing teeth. The design may be modified and is approved by the user and then conveyed to the implant production device 170.

FIG. 9 provides a perspective view of the implant production device 170. A blank 905, (comprised of titanium or other biocompatible material) is held within a work area that is accessible through door 904. The blank 905, of titanium or other biocompatible material, that is inserted into the implant production device 170 may, for example, have a shape that is similar to the shape of the dental implant 130 to be produced. By selecting a blank 905 to be machined that is similar in shape and size (but preferably slightly larger) to the final design of the dental implant to be produced, machining time will be reduced as less material will be needed to be removed from the similarly shaped blank. The x-axis carriage 910 is used to move tools back and forth into engagement with the blank 905. The x-axis carriage 910 includes a first and second frame that both slide on rails on subframe 912. Subassembly 940 (FIG. 12) having y-axis carriage 942 and z-axis carriage 943 is used to control the y-axis and z-axis movement of the mandrel 960 and blank 905. The CPU, memory and other electronics for implant production device 170 are located in compartment 907, FIG. 9. These can selectively be controlled, or activity displayed on display 906 of implant production device 170. For further details on the implant production device, reference can be made to U.S. patent application Ser. No. 10/917,069 filed Aug. 12, 2004 for “Improved Milling Machine” which is incorporated in its entirety by reference.

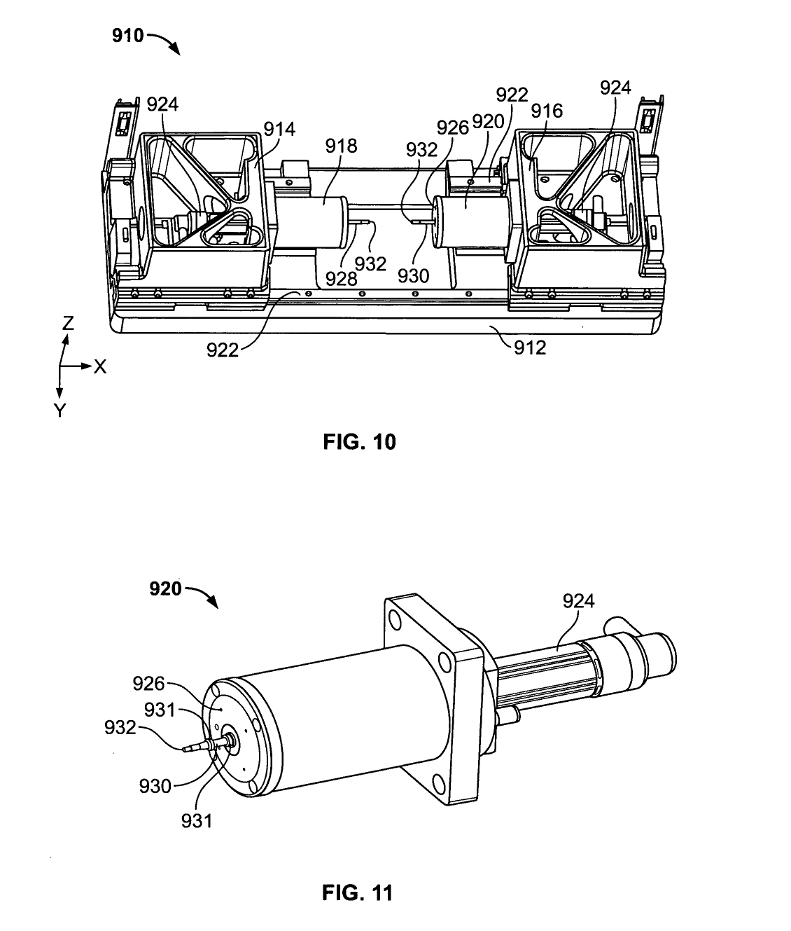

FIG. 10 is an isolated view of the x-axis carriage 910. It includes a first frame 914 and a second frame 916. In one embodiment, these frames are formed from a single block of metal. A first and second spindle 918, 920 are coupled to these frames 914, 916. The frames 914, 916 move on a single pair of rails 922 to ensure alignment. Each frame is coupled to a first and second spindle, wherein each spindle has a central axis. The central axis of each spindle is aligned. Tools 928 and 930 are accepted into the spindles along this axis. The spindles 918, 920 rotate the tools 928, 930 so that a cutting surface on the tool can carve away material from the blank as desired. Air streams emit from the spindle ports 926, FIG. 11, to cool the spindles and motors during milling. Motors 924, FIG. 10, are used to supply the power to move the frames along the rails and to rotate the tools within the spindles. Tools 928 and 930 held by first and second spindles 918, 920, respectively, are manipulated on the x-axis carriage to mill titanium blank 905. The x-axis carriage 910 advances spindles 918, 920 such that the grinding tools 928, 930 engage and make contact with the titanium blank 905. The titanium blank 905 seated at the mandrel 960 (FIG. 12) is positioned in the y-axis and z-axis by use of the y-axis carriage 942 and z-axis carriage 943.

The outer contour of the imaged tooth 120, FIG. 1, is reproduced at the implant production device 170. This requires an accurate understanding of the location of the tip of the tools and the x, y, z coordinates of the blank 905. Thus the shape and length of the mandrel 960, FIG. 12, holding the blank 905 must be precise. Motors 924 are used to move the x-axis carriage 910 shown in FIG. 10. This same level of precision is reproduced for the y and z axes. However, rather than move spindles, the mandrel 960 holding blank 905 is moved in the y and z axes by the subassembly 940 having y-axis carriage 942 and z-axis carriage 943 shown in FIG. 12. In FIG. 12, the y-axis 942 is controlled by moving y-axis carriage along rails oriented in the “y” direction. Movement along the z-axis is accomplished by z-axis carriage 943 powered for movement by motor 945. The y-axis carriage 942 includes the frame for engaging the mandrel 960 and automatic tool changer 950. This view also illustrates the location of the mandrel 960 and blank 905 to be milled on the y-axis carriage 942. Movement of the y-axis carriage 942 is powered by a y-axis motor (not shown). A cam 962 is used to secure the mandrel in place. The tool changer 950 can carry several additional tools 928, 930 for placement into the spindles. The tool changer 950 also includes at least one open port 954 for accepting the tool in the spindle.

FIG. 11 provides a more detailed view of the spindle 920 and the tool 930. The tool 930, shown in FIG. 11, includes a distal end that is engaged within the spindle. Flanges 931, FIG. 11, serve the purpose of assisting with the registration of the tool and the blank. In other words, even though the exact length of the tool 930 is known, the x, y, z coordinates of its tip 932 is also known. When the tool 930 is engaged into the spindle 920, the flange 931 acts as a travel limit and thus defines the distance between the tip and the spindle. Thus, when the spindle 920 moves along the x-axis, the position of the tip 932 of the tool 930 will be known. In addition to knowing the exact x, y, and z coordinates of the tool tips, the position of the blank 905 is also known. This requires that the mandrel 960 and blank 905 be consistently placed into the implant production device. The mandrel 960 and blank 905 engage a mandrel socket that in turn engages the y-axis carriage 942, FIG. 12, to consistently position the mandrel for milling operation.

Each tool 928, 930 is indirectly rigidly attached to the x-axis carriage 910 aligned to move along the x-plane, which are moved by a motors 924 as shown in 10. In addition, the mandrel 960, FIG. 12, is rigidly attached to subassembly 940 which is moved in the y and z directions via separate motors on each of the y and z assemblies. In this example, a total of four motors move a total of four carriages. These four separate motion directions may be referred to as “X-left”, “X-right”, “Y” and “Z”. The origin of the coordinate system in the milling machine may be defined in any way. One choice for the origin of the coordinate system for each of the “X-left”, “X-right”, “Y” and “Z” axes may be located at the end of the mandrel, in the center of the mandrel. Exact motions along each of the axes may be chosen in a coordinated motion by sending coordinated information to each of the motors simultaneously. Such coordinated motion may include position, speed, acceleration, jerk and time information, which instructs each motor to be at a given location with a given speed and/or acceleration and/or jerk value at a particular point in time. This may be done, for example, by an electronic motion control board (located at compartment 907), which is attached via cables or wires to each of the motors. The motion control board is attached in compartment 907, FIG. 9, to the central processing unit in the milling machine, which instructs the motors via the motion control board to implement a coordinated motion profile. In this way, the tool tips 932 may be instructed to trace a specified and precise contour in a coordinated fashion, while the mandrel 960 traces a specified and precise contour coordinated with the tips 932 of tools 928, 930.

The relative motion between the tool tips 932 and the block of material 905 attached to the mandrel 960 is then controlled very precisely, and may correspond to the three-dimensional shape of the implant to be machined. The computed trajectory of the tool tips 932 relative to the blank 905 on the mandrel 960 will take into account the shape of the tools 928, 930, the wear or condition of the tools, the size of the tools, and other aspects such as the level of accuracy required in the final machined implant, or the surface quality or texture of the final machined implant.

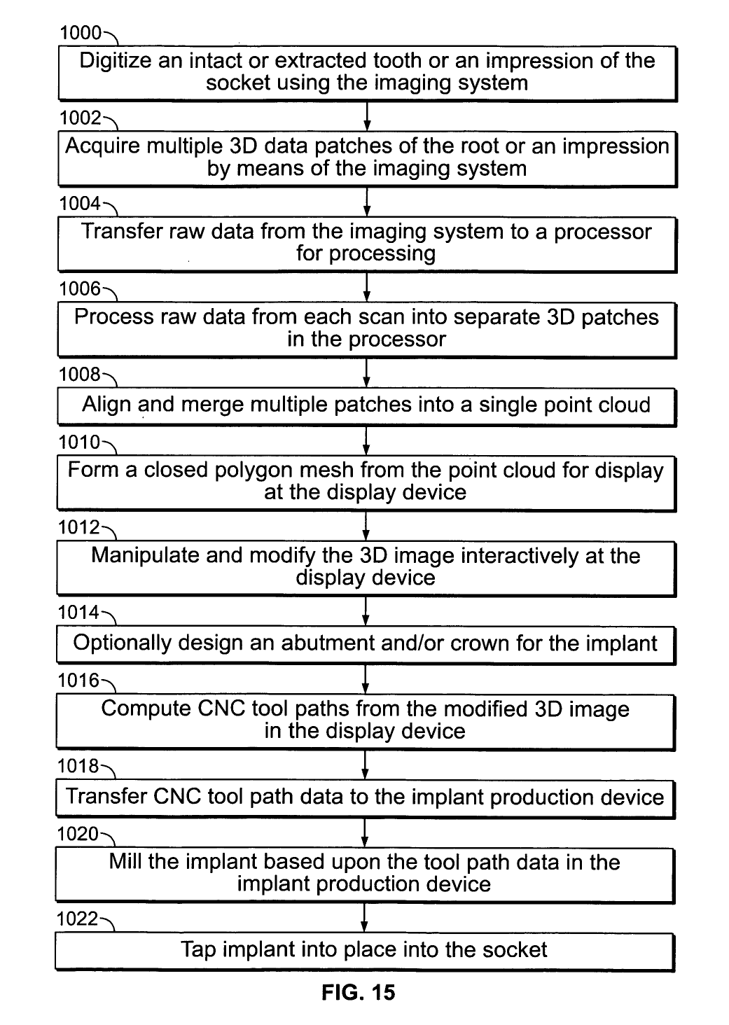

Referring now to FIG. 15, one example of the steps of producing a dental implant from a dental item such as a tooth or dental impression at the dental implant production system 100 is provided. In step 1000, a dental item such as an intact tooth, extracted tooth or a dental impression of the socket previously retaining an extracted tooth is scanned and digitized using the lazer digitizer imaging system 140. In step 1002, the imaging system 140 acquires multiple three-dimensional data patches of the portions of the tooth (e.g. root portions) or the dental impression being scanned. The raw data obtained by the imaging system 140 digitizing the dental item is transferred to a processor of the imaging system coupled to the display device 150 to be processed in step 1004. The processing may be accomplished at the imaging system 140 or alternatively performed at a display device 150 having processing capabilities. In step 1006, the processor processes the raw data from each scan performed by the imaging system 140 and separates the raw data from each scan into three-dimensional patches.

In step 1008, alignment and merging of the multiple three-dimensional data patches into a single point cloud is performed by the processor of imaging system 140 coupled with the display device 150. In step 1010, a closed polygon mesh is formed from the point cloud and is displayed at the display device 150. Production of polygon meshes from point cloud data into three-dimensional models is performed by the processor. In response to user interaction, via the user interface 160, the processor coupled with the display device 150 receives instructions relating to the modification of the displayed image and manipulates and modifies three-dimensional image model in accordance with the interactive instructions provided by the user in step 1012.

In step 1014, the user may selectively design an abutment or crown for the dental implant by modifying the displayed image at display device 160 through interaction with the user interface 160 coupled to the processor. Alternatively, the processor may be pre-programmed to automatically generate an abutment or dental crown design extending from a root portion of the imaged dental item based on preselected parameters relating to the images of the dental item.

In step 1016, the processor at the imaging system 140 coupled to the display device 150 computes CNC tool-paths from the modified three-dimensional image model that may be displayed at the display device. In step 1018, the CNC tool-path data is transferred from the processor coupled with display device 150, at imaging system 140, to the implant production device 170. Alternatively, the modified three-dimensional image data may be transferred to the implant production device and the computation of the CNC tool-path data is performed at the implant production device. In step 1020, the implant production device 170 machines the dental implant based on the tool-path data. In step 1022, the produced dental implant is placed into the socket that previously retained an extracted tooth.

Although embodiments of the invention are described in detail, it should be understood that various changes, substitutions and alterations can be made hereto without departing from the spirit and scope of the invention as described by the appended claims. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method of producing a dental fixture, comprising:
creating a three-dimensional image of at least a portion of a dental item;
sending data associated with the three-dimensional image to an implant production device; and
producing a dental implant in response to receipt of the data associated with the three-dimensional image.

2. The method of claim 1 wherein the dental item comprises at least one of: a) a tooth and b) a dental impression.

3. The method of claim 2 further comprising imaging the dental item after it is removed from a mouth.

4. The method of claim 2 further comprising imaging the dental item with an intra-oral laser digitizer imaging system before it is removed from a mouth.

5. The method of claim 2 wherein the dental item is a tooth and further comprising forming the dental implant to mimic a shape of at least a portion of a root of the tooth.

6. The method of claim 2 further comprising milling a solid piece of material at the implant production device to form the dental implant based on the data received from an imaging system.

7. The method of claim 6 further comprising inserting, into the implant production device, a blank of the solid piece of material that has a shape that is similar to a shape of the dental implant to be produced.

8. The method of claim 6 wherein the solid piece of material is comprised of titanium blank and the implant production device is a milling machine.

9. The method of claim 8 further comprising utilizing tools that are manipulated on an x-axis carriage to mill the titanium blank.

10. The method of claim 9 further comprising holding a first and a second tool in a first and a second spindle coupled to the x-axis carriage, and advancing the first and second spindles such that the first and second tools contact the titanium blank.

11. The method of claim 10 further comprising positioning the titanium blank using a y-axis carriage and a z-axis carriage.

12. The method of claim 6 further comprising adjusting data associated with a size of the three-dimensional image to produce the dental implant with a size that is different than the portion of the dental item being imaged.

13. The method of claim 12 further comprising enlarging a thickness of a portion of the implant relative to a corresponding portion of the dental item being imaged.

14. The method of claim 12 further comprising modifying data associated with a root portion of the image of the dental item such that a corresponding root portion of the dental implant is omitted by the implant production device.

15. The method of claim 12 further comprising selectively modifying data associated with a surface of the three-dimensional image of the portion of the dental item, and producing the dental implant to have a surface associated with the modified surface of the imaged portion of the dental item.

16. The method of claim 12 further comprising displaying the three-dimensional image of the dental item.

17. The method of claim 6 wherein the dental item is a tooth and further comprising selectively modifying a shape of the three-dimensional image such that the produced dental implant is able to be seated into a fresh socket of a jawbone which previously held the tooth, to stabilize the implant in the jawbone and restrict growth of soft tissue into the socket.

18. The method of claim 17 further comprising modifying the shape of the three-dimensional image to create an abutment portion extending from a root portion of the three-dimensional image,
positioning the abutment portion of the three-dimensional image at an angle relative to the root portion of the three-dimensional image to mimic an angle between a root portion of the tooth and a non-root portion of the tooth.

19. The method of claim 6 further comprising forming the dental implant with a relatively wide portion proximate to an occlusal part of the implant.

20. The method of claim 6 further comprising modifying the data associated with the three-dimensional image to design an abutment portion of the three-dimensional image of the dental item, and
producing, at the implant production device, an abutment portion as part of the dental implant such that the abutment portion of the dental implant is positioned at an occlusal part of the dental implant.

21. The method of claim 20 wherein the abutment portion of the dental implant corresponds to the design for the abutment portion of the three-dimensional image in accordance with the modified data.

22. The method of claim 20 further comprising placing a prosthesis over at least a portion of the abutment portion of the dental implant.

23. The method of claim 6 further comprising forming an abutment as part of the dental implant.

24. The method of claim 23 further comprising imaging a crown portion of a tooth,
sending information associated with the imaged crown portion of the tooth to the implant production device, and
producing a dental crown prosthesis at the implant production device in response to receipt of the information associated with the crown portion of the tooth.

25. The method of claim 6 further comprising scanning a multi-axis collimated beam of light in a predetermined pattern, where the pattern includes a plurality of substantially parallel curves,
focusing the scanned collimated beam of light on the dental item,
capturing an image of the formed collimated beam of light on the dental item during an exposure period, and
determining a map of a surface of at least a portion of the dental item based on the captured image.

26. The method of claim 25 further comprising placing the dental item in an object positioning device configured to position the dental item within a field of projection for a scanner.

27. The method of claim 6 further comprising utilizing optical coherence tomography to image a root portion of the dental item.

28. The method of claim 2 wherein the dental item is a dental impression and further comprising inserting impression material into a socket of a mouth of a patient to form the dental impression,
imaging at least a portion of the dental impression, and
preparing the dental implant at an implant production device in response to imaging at least a portion of the dental impression.

29. The method of claim 28 further comprising extracting a tooth from the mouth of the patient,
performing dental procedures to the socket from where the tooth was extracted to create a prepared site, and
inserting the impression material into the prepared site.

30. A dental implant production system, comprising:
an imaging system that creates a three-dimensional image of at least a portion of a dental item; and
an implant productional device coupled to the imaging system which receives data associated with the three-dimensional image of the dental item, the implant production device produces a dental implant in response to receipt of the data associated with the three-dimensional image.

31. The system of 30 wherein the dental item comprises at least one of: a) a tooth and b) a dental impression.

32. The system of claim 31 wherein the dental item is a tooth and the implant production device forms the dental implant to mimic a shape of at least a portion of a root of the tooth.

33. The system of claim 32 wherein the imaging system includes a scanner which optically scans the root of the tooth.

34. The system of claim 32 wherein the imaging system is an intra-oral laser digitizer imaging system that images a root portion of the tooth before it is removed from a mouth.

35. The system of claim 34 in which the intra-oral laser digitizer imaging system utilizes optical coherence tomography to image the root portion of the tooth.

36. The system of claim 31 wherein the implant production device is a milling machine which is programmable to mill a solid piece of material to form the dental implant based on the data received from the imaging system.

37. The system of claim 36 wherein the solid piece of material comprises a titanium blank.

38. The system of claim 37 wherein the titanium blank has a shape that is similar to a shape of the dental implant to be produced.

39. The system of claim 37 in which the milling machine further comprises an x-axis carriage having a first spindle and a second spindle that are axially aligned, a y-axis carriage that adjusts the position of the titanium blank, and a z-axis carriage.

40. The system of claim 39 further comprising a first tool and a second tool held at the first spindle and second spindle respectively for milling the titanium blank.

41. The system of claim 31 further comprising a user interface coupled with the imaging system which allows for selective adjustment of a size of the three-dimensional image such that the implant production device can produce a dental implant having a size that is different than the portion of the dental item being imaged.

42. The system of claim 41 further comprising a display device coupled with the imaging system that displays the three-dimensional image of the dental item.

43. The system of claim 42 wherein the imaging system modifies data associated with a surface of the three-dimensional image in response to user input at the user interface, and wherein the implant production device responsively produces the dental implant having a surface associated with the data for the modified surface of the imaged portion of the dental item.

44. The system of claim 30 wherein the dental item comprises a tooth and further comprising a user interface coupled with the imaging system, the imaging system, in response to user input at the user interface, selectively adjusts data associated with the shape of the three-dimensional image such that the dental implant produced at the implant production device is able to be seated into a fresh socket of a jawbone which previously held the tooth.

45. The system of claim 44 wherein the imaging system, in response to user input at the user interface, is capable of selectively adjusting the shape of the three-dimensional image such that the implant production device forms the dental implant with a relatively wide portion proximate a top end of the implant.

46. The system of claim 44 wherein the implant production device is capable of producing the dental implant with a facility to screw an abutment into the dental implant.

47. The system of claim 30 wherein the imaging system is a laser digitizer imaging system which comprises a light source having collimating optics configured to generate a collimated beam of light,
a scanner optically coupled to the light source and configured to scan the collimated beam along at least two axes towards the tooth to be imaged,
an image capture instrument having an optical axis at an angle θ with respect to the scanner and configured to detect a reflection of the scanned beam from the object and to generate data representative of a surface of the tooth based on the reflected beam, and
a processor coupled to the scanner and the image capture system configured to generate the three-dimensional image of the dental item based on the data.

48. The system digitizer of claim 47 further comprising a flat-field scan lens having an optical axis and configured to focus the scanned beam of light to a point on the dental item to be imaged.

49. The system of claim 48 where the image capture instrument comprises:
an image sensor configured to detect a triangulation image of the dental item, the triangulation image based on a plurality of curves generated by scanning the beam of light on the dental item during an exposure period, and
a telecentric lens configured to focus the plurality of curves on the image sensor.

50. The system of claim 49 further comprising an object positioning system configured to position the dental item within a field of projection of the scanner.

51. The system of claim 50 where the object positioning system is configured to move the dental item to various positions and angles with respect to a field of view of the image sensor instrument and the scanner.

52. The system of claim 51 where the processor is programmed to merge multiple images of the dental item to create a three-dimensional map of the dental item.

53. The system of claim 48 where the scanner further comprises a programmable position controller configured to control the scan of the collimated laser beam to a programmed scan sequence.
